(19) United States
(12) Patent Application Publication
(10) Pub. No.: US 2023/0371529 A1
(43) Pub. Date: Nov. 23, 2023

(54) Retortable Food Products

(71) Applicant: Frito-Lay North America, Inc., Plano, TX (US)

(72) Inventors: Shreeya Ravisankar, Plano, TX (US); Renu Mathew, Plano, TX (US); Akhilesh Gautam, Plano, TX (US); Thomas Trezza, Plano, TX (US); Kimberly Krenek, Plano, TX (US)

(21) Appl. No.: 17/747,094

(22) Filed: May 18, 2022

(51) Int. Cl. A21D 13/066; A21D 2/18

(52) U.S. Cl. CPC A21D 13/066; A21D 2/186; A23L 7/109

(57) ABSTRACT

A retorted gluten-free pasta product that survives retort may be formed by preparing a dry mix that includes (a) a gluten-free flour that includes (i) a non-cereal flour or pulse flour, (ii) a cereal flour, or (iii) mixtures thereof, (b) a starch, and (c) an emulsifier. The dry mix may be combined with water to form a dough that can be extruded at a temperature and with an amount of mechanical energy effective to form an extruded pasta product having a bi-continuous matrix of protein and starch. The pasta product can be incorporated with a sauce into a closed retort container and subsequently retorted. The resulting retorted food product may contain gluten-free pasta that has the structural integrity and textual firmness consistent with that exhibited by traditional wheat pasta after having undergone retort.

This disclosure relates to food products and, more particularly, to retorted and retortable food products that contain pasta in a sauce.

### BACKGROUND

A variety of pre-cooked, shelf-stable foods are commercially available. These food products are often made shelf stable by retorting the product during production, which sterilizes the product to provide a longer shelf life. Generally, retorted food products are prepared by combining, before, during, or after packing the individual ingredients in a retort container and then thermally processing the container. The ingredients may be precooked prior to being added to the container or may be cooked in the container during the process of retorting. In either case, the container can be sealed and thermally processed using a retort sterilization process. Retort sterilization typically involves heating the retort container and food ingredients contained in the container at a high temperature for a period of time sufficient to achieve commercial sterility of the food product. The process often occurs at high pressure and high temperature in a retort vessel during commercial production.

With that in mind, gluten flour-based pasta and noodles in retorted packages are commonly available. For example, soups, pastas, and other noodle-containing products are typical commercially available retorted food products containing gluten flour based pasta. Traditionally, gluten containing pasta included in retorted food products are made of wheat. Wheat contains the protein complex gluten, which helps to hold the pasta structure together and to survive the high temperature and pressure conditions of retort. While wheat-based pasta in retorted products continues to find widespread applicability, certain consumer groups focus on purchasing product free of wheat and gluten. For example, individuals that have a wheat allergy or gluten autoimmune disorder caused by Celiac disease need to avoid wheat or gluten in their diet to prevent adverse health effects. Unfortunately, traditional gluten-free alternatives to wheat-based pasta cannot survive the retort conditions.

In addition, certain consumer groups seek to include healthy alternatives in their daily diet and thus, they look to replace wheat-based (gluten-based) pasta and noodles with pasta formed from gluten-free flour such as flour from one or more of corn, white rice, brown rice, almond, quinoa, chickpeas, lentils, glucomannan, buckwheat, amaranth, and millet. Unfortunately, it has been found that the taste, texture, and sauce absorption of these alternative pastas generally do not match that of the wheat-based pastas. For example, it has been noticed that pastas formed from high protein flour do not approach or come close to replicating the taste of wheat-based pastas, and many have a mushy or grainy texture, which negates the pleasure from eating pasta. To counteract the apparent texture problems, it has been sought to make the pasta thicker, which may provide the noodles a chewy texture but many consumers do not like a more chewy texture.

It has also been found that these alternative pastas do not absorb sauce or do not absorb sauce as well as the wheat-based pastas. As a result, the amount of sauce used to provide a palatable and enjoyable product is greater than that required for wheat-based pastas. Unfortunately, this increases the total amount of calories provided by the product, which may negate the sought-after healthy attributes desired by the use of alternatives to wheat-based (gluten-based) pastas.

### SUMMARY

The described retorted food product addresses these issues by providing a retorted pasta product that contains a gluten-free pasta product in combination with a sauce. The gluten-free pasta products may have sufficient structural integrity to survive retort conditions without disintegrating or structurally decomposing. As a result, the gluten-free pasta products can be combined with a sauce and incorporated into a retort container to be retorted to provide a shelf-stable retorted food product.

To produce a gluten-free pasta product that survives retort conditions, appropriate constituent gluten-free ingredients may be selected and processed in a manner to produce a resulting product that survives retort while also providing textual firmness and sauce absorption desired by consumers. Different factors that may influence the quality and efficacy of the gluten-free pasta products include the characteristics of the gluten-free flour used to produce the pasta, the processing conditions under which the gluten-free flour is transformed into a pasta product, and the resulting structural characteristics of the pasta product.

Without wishing to be bound by any particular theory, some examples of a gluten-free pasta product according to the disclosure are believed to exhibit enhanced retort survivability as a result of a synergistic combination of a gluten-free flour (e.g. non-wheat flour) in combination with a starch and emulsifier, which creates a bi-continuous matrix of protein and starch that forms a desirable structure of the pasta product. The bi-continuous matrix of protein and starch may be characterized by having continuous and semi-continuous phases of interconnected starch molecules dispersed among continuous and semi-continuous phases of interconnected protein molecules. Accordingly, instead of being formed primarily of discrete particles of intermixed protein and starch, the pasta may instead have a networked structure formed of interwoven strands of protein and starch. The mechanical strength of this structure can provide a pasta product that survives retort while still exhibiting sufficient textual firmness even without having gluten protein to act as a binder and rigidity agent.

To form a gluten-free pasta product that survives retort, a gluten-free flour may be selected as a starting ingredient. The gluten-free flour may include (i) a non-cereal or pulse flour, (ii) a cereal flour or (iii) mixtures thereof. Legumes are plants in the family Fabaceae or the fruit or seed of such a plant. When used as a dry grain, as in the following description, the seed is also called a pulse. Thus, while a pulse typically refers to legume crops harvested solely for the dry seed, in the following description, unless specifically noted otherwise, references to pulse flours include legume flours.

The gluten-free flour is combined with a starch and an emulsifier to form a dry mix. The dry mix may then be combined with an appropriate amount of water to form a dough that can be further processed to form a pasta product. For example, the dough may be extruded with an amount of mechanical mixing energy and thermal energy effective to form a pasta product having retort survivability characteristics. To this end, the dough may be processed in an extruder with an amount of mechanical mixing energy and/or thermal energy to effectively form an extruded pasta product having a structure with a bi-continuous matrix of protein and starch.

The extruded pasta dough may be extruded through an appropriate die head to create a desired shape. Alternatively, the pasta dough, whether extruded or not, may be sheeted or formed into geometries that cannot be created using an extruder die head. Independent of the resulting specific internal dough structure of the pasta product, the pasta product may be used immediately, may be dried or may be frozen prior to being combined with a sauce either before, during, or after incorporating the pasta product in a retort container, which is thereafter subjected to retort conditions. Advantageously, the resulting retorted pasta product exhibits suitable textural firmness and sauce uptake without substantially disintegrating or decomposing and may have a texture comparable to conventional wheat pasta.

In one example, a process for preparing a retorted pasta product is described. The process includes preparing a dough mixture by admixing a gluten-free flour with a starch and emulsifier to form a dry mix that is combined with water to form an extrudable pasta dough. The pasta dough may be extruded at a temperature and with an amount of mechanical energy effective to form an extruded pasta product having a bi-continuous matrix of protein and starch. The method further involves incorporating the extruded pasta product along with a sauce into a closed container and retorting the extruded pasta product in the closed container to produce the retorted pasta product.

The sauce with which the pasta product is mixed can be any consumer suitable and desired type of sauce. In this regard, the sauce may be primarily a liquid so that the pasta product is surrounded by and can uptake or absorb some of the sauce. Further, the sauce may be tomato-based sauce such as Marinara, or Alfredo, Bolognese, Amatriciana, Frutti di mare, Salsa di Noci, Pesto, Pomodoro, Bechamel, Vodka sauce, butter garlic, and the like. The sauce may contain other ingredients such as spices, for example, oregano, parsley, basil; flavorings, for example, garlic, sugar, pepper, chili flakes, onion; corn syrup; vegetable oil; salt; and the like. Of course, the ingredients used and the amounts of ingredients will be determined by the taste desired for the sauce component.

In another example, a retorted food product is described that includes a container having undergone retort that contains a retorted pasta product and sauce where the pasta has a bi-continuous matrix of protein and starch. The retorted pasta product may exhibit a textural firmness, measured as described below, of at least about 300 grams and, in some instances exhibit a textural firmness between about 300 grams and about 550 grams.

The details of one or more examples are set forth in the accompanying drawings and the description below. Other features, objects, and advantages will be apparent from the description and drawings, and from the claims.

As used in the following description, “gluten-free” means a gluten content less than 5 weight percent.

All percentages used or recited in this description refer to a percent by weight, unless specifically stated otherwise. Other aspects and advantages of this invention will be appreciated from the following detailed description.

### BRIEF DESCRIPTION OF DRAWINGS

FIG. 1 is a flow diagram illustrating an exemplary process for forming a retortable gluten-free pasta product.

FIG. 2 shows the results of a Rapid Visco Analyser test of several pastas before retort and it is believed that the peak viscosity may indicate one or more of the water-holding (and thus sauce holding) capacity and/or the degree of retrogradation of the starch present in the pasta product.

FIG. 3 shows the results of a textural firmness analysis of several pastas after retorting in sauce.

### DETAILED DESCRIPTION

In general, this disclosure is directed to retorted food products such as gluten-free pasta products and techniques for producing the retorted food products. In some instances, the gluten-free pasta product is formed by combining a gluten-free flour with a starch and an emulsifier to form a dry mix that is then combined with an appropriate amount of water to form a dough that can be further processed to form a pasta product.

### Process

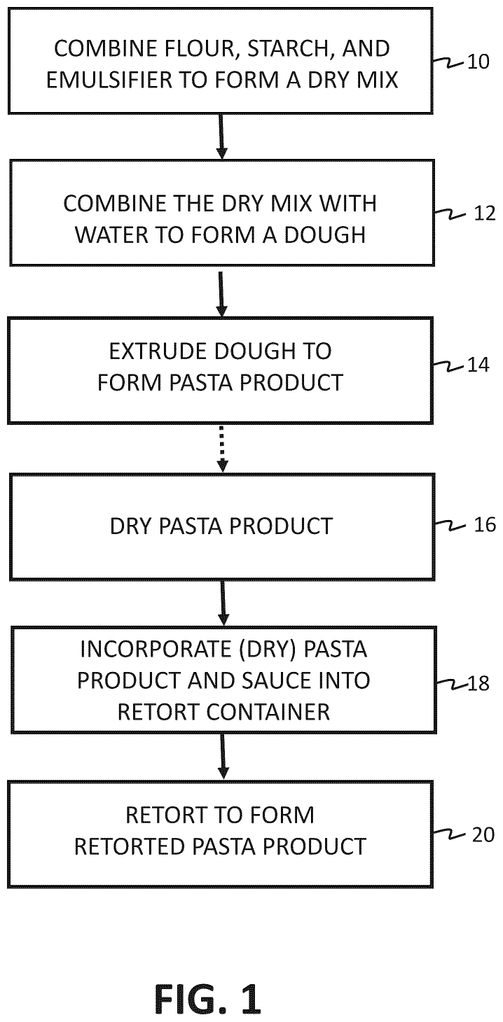

FIG. 1 is a flow diagram that illustrates one embodiment of a process for forming a retorted gluten-free pasta product. The process includes combining one or more of a gluten-free flour, a starch, and an emulsifier to form a dry mix (10) and thereafter combining the dry mix with a suitable amount of water to form a dough (12). The dough may be extruded and shaped through a die plate or otherwise to form a pasta product (14), which may optionally be dried (16). Thereafter, the pasta product is incorporated into a retort container with a sauce (18) and then retorted to form a retorted pasta product (20).

Dry Mix

The dry mix includes a gluten-free flour, starch and an emulsifier The gluten-free flour may be (i) a non-cereal or pulse flour, (ii) a cereal flour, or (iii) mixtures thereof. The gluten-free flour may be substantially devoid of gluten. Gluten is a protein complex that can be found in the Triticeae tribe of grains, which includes wheat, barley and rye. The gluten content in flour may provide organoleptic properties, such as texture and taste, to a pasta product formed of such a flour. The described gluten-free flour lacks these gluten protein molecules and the resulting structural characteristics provided by the gluten molecules. As noted above, the term “gluten-free” means having a gluten content less than 5 weight percent. In some examples, a gluten-free product or ingredient has a gluten content less than 3 weight percent, such as less than 1 weight percent, or approximately 0 weight percent.

In some examples, the protein in the gluten-free flour is a native, unprocessed protein. In general, native, unprocessed proteins may be considered as those proteins that have not been denatured. During denaturation, proteins may lose the quaternary structure, tertiary structure and secondary structure that is present in their native state. Accordingly, a denatured protein may have characteristics or properties that have been altered such as by heat, enzyme action, or chemicals that cause the protein to lose some of its biologic activity. By utilizing a native, unprocessed protein, the protein molecules in the gluten-free flour may solubilize and aggregate and/or react and bind during subsequent extrusion to form a networked protein matrix structure that may not otherwise form if using a denatured protein.

The non-cereal or pulse flours may be selected from one or more of Amaranth grain, quinoa and buckwheat, baked beans, navy beans, kidney beans, mung beans, soybeans, chickpeas, lentils and split peas, dry beans, dry broad beans, dry peas, cow peas, pigeon peas, Bambara beans, vetches, lupins and pulses nes and varieties of these. The cereal flours may be selected from one or more of non-gluten containing grains such as rice, oats, barley, corn, rice, oats, and maize. Depending on the desired characteristics of the pasta dough and resulting pasta product, the dry mix can be formed using a single flour or a combination (e.g., mixture) of multiple flours.

In some examples, the gluten-free flour is a flour manufactured from a legume, which include pulses. The Food and Agricultural Organization of the United Nations recognizes eleven primary pulses: Dry beans (Phaseolus) such as kidney bean, navy bean, pinto bean, haricot bean (Phaseolus vulgaris); lima bean, butter bean (Phaseolus lunatus); azuki bean (Vigna angularis); mung bean, golden gram, green gram (Vigna radiata); black gram, urad (Vigna mungo); scarlet runner bean (Phaseolus coccineus); ricebean (Vigna umbellata); moth bean (Vigna aconitifolia); and tepary bean (Phaseolus acutifolius), 2. Dry broad beans (Vicia faba) such as horse bean (Vicia faba equina); broad bean (Vicia faba); and field bean (Vicia faba), 3. Dry peas (Pisum) such as garden pea (Pisum sativum), protein pea (Pisum sativum), 4. Chickpea, garbanzo, Bengal gram (Cicer arietinum), 5. Dry cowpea, black-eyed pea, blackeye bean (Vigna unguiculata), 6. Pigeon pea, Arhar/Toor, cajan pea, Congo bean, gandules (Cajanus cajan), 7. Lentil (Lens culinaris), 8. Bambara groundnut, earth pea (Vigna subterranea), 9. Vetch, common vetch (Vicia sativa), 10. Lupins (Lupinus), and 11. Minor pulses such as lablab, hyacinth bean (Lablab purpureus); jack bean (Canavalia ensiformis); sword bean (Canavalia gladiata); winged bean (Psophocarpus tetragonolobus); Velvet bean, cowitch (Mucuna pruriens); and yam bean (Pachyrhizus erosus).

A flour formed from one or more of the foregoing legumes and pulses may be beneficially used as the gluten-free flour for forming the gluten-free pasta product. In one example, a gluten-free flour may include a combination of lentil and chickpea flours. In another example, the gluten free flour may be formed from a combination of red lentil, white rice, and pea protein flours. In yet another example, the gluten free flour may be formed from a combination of corn, rice, and quinoa flours.

The amount of gluten-free flour present in the dry mix will depend, in part, on the type of flour sought to be used. For example, when a non-cereal or pulse flour is the primary or sole gluten-free flour present in the dry mix (i.e., the dry mix does not contain a cereal flour), the non-cereal or pulse flour may be present in the dry mix in amounts equal to or greater than 50%. In this regard, the non-cereal or pulse flour may be present in the dry mix in an amount of about 50%, 55%, 60%, 65%, 70%, 75%, 80%, 85%, or 90%. In other words, the non-cereal or pulse flour may be present in the dry mix in a range from about 50% to about 90%, about 50% to about 85%, about 50% to about 80%, about 50% to about 75%, about 50% to about 70%, about 50% to about 65%, about 50% to about 55%, or from about 55% to about 90%, about 55% to about 85%, about 55% to about 80%, about 55% to about 75%, about 55% to about 70%, about 55% to about 65%, about 55% to about 60%, or about 60% to about 90%, about 60% to about 85%, about 60% to about 80%, about 60% to about 75%, about 60% to about 70%, about 60% to about 65%, or about 65% to about 90%, about 65% to about 85%, about 65% to about 80%, about 65% to about 75%, about 65% to about 70%, or about 70% to 90%, about 70% to about 85%, about 70% to about 80%, about 70% to about 75%.

When a cereal flour is the primary or sole gluten-free flour present in the dry mix (i.e., the dry mix does not contain a non-cereal flour or pulse), the cereal flour may be present in the dry mix in amounts equal to or greater than 50%. In this regard, the cereal flour may be present in the dry mix in an amount of about 50%, 55%, 60%, 65%, 70%, 75%, 80%, 85%, or 90%. In this regard, the cereal flour may be present in the dry mix in a range from about 50% to about 90%, about 50% to about 85%, about 50% to about 80%, about 50% to about 75%, about 50% to about 70%, about 50% to about 65%, about 50% to about 55%, or from about 55% to about 90%, about 55% to about 85%, about 55% to about 80%, about 55% to about 75%, about 55% to about 70%, about 55% to about 65%, about 55% to about 60%, or about 60% to about 90%, about 60% to about 85%, about 60% to about 80%, about 60% to about 75%, about 60% to about 70%, about 60% to about 65%, or about 65% to about 90%, about 65% to about 85%, about 65% to about 80%, about 65% to about 75%, about 65% to about 70%, or about 70% to 90%, about 70% to about 85%, about 70% to about 80%, about 70% to about 75%.

Alternatively, when the gluten-free flour is formed from a mixture of (i) a non-cereal or pulse flour and (ii) a cereal flour, the mixture may be present in the dry mix in an amount equal to or greater than 50%. In this regard, the mixture may be present in the dry mix in an amount of about 50%, 55%, 60%, 65%, 70%, 75%, 80%, 85%, 90%, 91%, 92%, 93%, 94%, 95%, 96%, 97%, 98%, or 99%. In this regard, the non-cereal or pulse flour may be present in the dry mix in a range from about 50% to about 99%, about 50% to about 98%, about 50% to about 97%, about 50% to about 96%, about 50% to about 95%, about 50% to about 94%, about 50% to about 93%, about 50% to about 92%, from about 50% to about 91%, about 50% to about 90%, about 50% to about 85%, about 50% to about 80%, about 50% to about 75%, about 50% to about 70%, about 50% to about 65%, about 50% to about 55%, or from about 55% to about 99%, about 55% to about 98%, about 55% to about 97%, about 55% to about 96%, about 55% to about 95%, about 55% to about 94%, about 55% to about 93%, about 55% to about 92%, about 55% to about 91%, about 55% to about 90%, about 55% to about 85%, about 55% to about 80%, about 55% to about 75%, about 55% to about 70%, about 55% to about 65%, about 55% to about 60%, or from about 60% to about 99%, about 60% to about 98%, about 60% to about 97%, about 60% to about 96%, about 60% to about 95%, about 60% to about 94%, about 60% to about 93%, about 60% to about 92%, about 60% to about 91%, about 60% to about 90%, about 60% to about 85%, about 60% to about 80%, about 60% to about 75%, about 60% to about 70%, about 60% to about 65%, or from about 65% to about 99%, about 65% to about 98%, about 65% to about 97%, about 65% to about 96%, about 65% to about 95%, about 65% to about 94%, about 65% to about 93%, about 65% to about 92%, about 65% to about 91%, about 65% to about 90%, about 65% to about 85%, about 65% to about 80%, about 65% to about 75%, about 65% to about 70%, or from about 70% to about 99%, about 70% to about 98%, about 70% to about 97%, about 70% to about 96%, about 70% to about 95%, about 70% to about 94%, about 70% to about 93%, about 70% to about 92%, about 70% to about 91%, about 70% to 90%, about 70% to about 85%, 70 about % to about 80%, about 70% to about 75%, or from about 75% to about 99%, about 75% to about 98%, about 75% to about 97%, about 75% to about 96%, about 75% to about 95%, about 75% to about 94%, about 75% to about 93%, about 75% to about 92%, about 75% to about 91%, about 75% to 90%, about 75% to about 85%, 75 about % to about 80%, or from about 80% to about 99%, about 80% to about 98%, about 80% to about 97%, about 80% to about 96%, about 80% to about 95%, about 80% to about 94%, about 80% to about 93%, about 80% to about 92%, about 80% to about 91%, about 80% to 90%, about 80% to about 85%, of from about 85% to about 99%, about 85% to about 98%, about 85% to about 97%, about 85% to about 96%, about 85% to about 95%, about 85% to about 94%, about 85% to about 93%, about 85% to about 92%, about 85% to about 91%, about 85% to 90%, or from about 970% to about 99%, about 90% to about 98%, about 90% to about 97%, about 90% to about 96%, about 90% to about 95%, about 90% to about 94%, about 90% to about 93%, about 90% to about 92%, or about 90% to about 91%.

In addition to containing protein other than gluten, the dry mix may include a starch, whether as part of the gluten-free flour (i.e., an endogenous source of starch) or provided as an exogenous source (i.e., from a source other than the gluten-free flour present in the dry mix). In general, starch is a polymer formed of linked anhydro-a-D-glucose units. It may have either a mainly linear structure (amylose) or a branched structure (amylopectin). The molecular weight of the constituent polymers, particularly amylose, varies between different starch sources. In native, uncooked and ungelatinized form, the starch molecules amylose and amylopectin are located within starch granules that are insoluble in cold water. Flour, independent of the source and protein content, typically includes ungelatinized starch, such as uncooked, ungelatinized starch. The ungelatinized starch may have a semi-crystalline structure. By contrast, when the starch is cooked to provide cooked, pregelatinized starch, the starch granules can swell, burst, and lose their semi-crystalline structure.

The dry mix may have an amount of ungelatinized starch effective to form a pasta product that survives retort. The specific amount of ungelatinized starch may vary based on factors such as the amount of protein present in the gluten-free flour and the configuration and operating characteristics of the extrusion equipment used to extrude the pasta dough. In some examples, the gluten-free flour used to form the pasta dough does not contain pre-gelatinized starch. In other examples, however, the pasta dough may be formed using a gluten-free flour containing pre-gelatinized starch. Due to the presence of partially gelatinized starch when using flour containing pre-gelatinized starch, the extrusion conditions used to process the dough may be adjusted to achieve a final degree of starch gelatinization effective to form a bi-continuous matrix of protein and starch.

While the source of the starch may, in general be from any suitable source, in some instances, the starch may be provided by one or more of legume starches such as pea; root and tuber starches such as potato, rice, corn, tapioca, modified starch from rice, corn or tapioca and combinations thereof. In some instances, the starch is provided from an exogenous source. The exogenous starch may be a swelling starch such that it has good water holding capacity (and, in some instances may be pre-gelatinized) and swelling capacity to increase flexibility of the pasta and reduce its fragility.

The starch may be present in the dry mix in an amount from about 5%, 10%, 15%, 20%, 25%, 30% or about 35%. In this regard, the starch may be present in the dry mix in an amount of about 5% to about 35%, about 5% to about 30%, 5% to about 25%, 5% to about 20%, 5% to about 15%, 5% to about 10%, or from about 10% to about 35%, about 10% to about 30%, 10% to about 25%, 10% to about 20%, 10% to about 15%, or from about 15% to about 35%, about 15% to about 30%, 15% to about 25%, 15% to about 20%, or from about 20% to about 35%, about 20% to about 30%, 20% to about 25%, or from about 25% to about 35%, 25% to about 35%, or from about 30% to about 35%.

As discussed in greater detail below, the protein present in the gluten-free flour and the starch (whether present endogenously or exogenously) may react during extrusion to form a network that includes continuous and semi-continuous strands of protein interleaved with continuous and semi-continuous strands of starch. This resulting bi-continuous matrix structure may help impart characteristics of both retort survivability as well as textual firmness for the resulting retorted pasta product.

The dry mix may also contain an emulsifier which is believed to help with gel formation, maintaining the desired firm texture after retort, mouthfeel, expansion ratio, and absorption of water and sauce. The emulsifier may be any suitable edible emulsifier approved by the Food and Drug Administration. Suitable emulsifiers, include but are not limited to egg, lecithin, mono- and diglycerides of fatty acids or derivatives thereof.

The emulsifier may be present in the dry mix in amounts from about 0.5%, about 1%, about 1.5%, about 2%, about 2.5%, about 3%, about 3.5%, about 4%, about 4.5%, about 5%, about 5.5%, or about 6%. In this regard, the emulsifier may be present from about 0.5% to about 6%, about 0.5% to about 5.5%, about 0.5% to about 5%, about 0.5% to about 4.5%, about 0.5% to about 4%, about 0.5% to about 3.5%, about 0.5% to about 3%, about 0.5% to about 2.5%, about 0.5% to about 2%, about 0.5% to about 1.5%, about 0.5% to about 1%, or from about 1% to about 6%, about 1% to about 5.5%, about 1% to about 5%, about 1% to about 4.5%, about 1% to about 4%, about 1% to about 3.5%, about 1% to about 3%, about 1% to about 2.5%, about 1% to about 2%, about 1% to about 1.5%, or from about 1.5% to about 6%, about 1.5% to about 5.5%, about 1.5% to about 5%, about 1.5% to about 4.5%, about 1.5% to about 4%, about 1.5% to about 3.5%, about 1.5% to about 3%, about 1.5% to about 2.5%, about 1.5% to about 2%, or from about 2% to about 6%, about 2% to about 5.5%, about 2% to about 5%, about 2% to about 4.5%, about 2% to about 4%, about 2% to about 3.5%, about 2% to about 3%, about 2% to about 2.5%, or from about 2.5% to about 6%, about 2.5% to about 5.5%, about 2.5% to about 5%, about 2.5% to about 4.5%, about 2.5% to about 4%, about 2.5% to about 3.5%, about 2.5% to about 3%, or from about 3% to about 6%, about 3% to about 5.5%, about 3% to about 5%, about 3% to about 4.5%, about 3% to about 4%, about 3% to about 3.5%, or from about 3.5% to about 6%, about 3.5% to about 5.5%, about 3.5% to about 5%, about 3.5% to about 4.5%, about 3.5% to about 4%, or from about 4% to about 6%, about 4% to about 5.5%, about 4% to about 5%, about 4% to about 4.5%, or from about 4.5% to about 6%, about 4.5% to about 5.5%, about 4.5% to about 5%, or from about 5% to about 6%, about 5% to about 5.5%, or from about 5.5% to about 6%.

Dough

After the ingredients forming the dry mix are intimately combined, the dry mix is combined with an appropriate amount of water to form a dough (12) that may be processed in a suitable manner to form a pasta product (14). In one instance, the dry mix may be combined with an appropriate amount of water to form an extrudable pasta dough (12). Manipulating the type, quality, and quantity of gluten-free flour in the pasta dough along with subsequent extrusion characteristics may control the retort survivability characteristics of the resulting pasta product.

The amount of water combined with the dry mix can vary, e.g., depending on the type of flour used in the dough, the extrusion performance of the dough, and desired properties of the resultant product. Further, the water combined with the dry mix can either be added by itself (e.g., as tap water, distilled water) or as part of a water-containing liquid (e.g., milk, broth).

The amount of water combined with the dry mix may be effective to partially or fully hydrate the protein and starch molecules in the gluten-free flour, the starch and the emulsifier in the dry mix and also facilitate substantial or full dispersion of the ingredients in the dough, e.g., such that the dough is compositionally consistent. For example, the amount of water combined with the dry mix may be effective to partially or fully hydrate each of the components forming the dry mix during subsequent mixing and/or heating during extrusion.

To this end, the dough may contain from about 25% water, or from about 26%, about 27%, about 28%, about 29%, about 30%, about 31%, about 32%, about 33%, about 34%, about 35%, about 36%, about 37%, about 38%, about 39%, or about 40%, with the balance of the dough comprising the dry mix. As such, the dough may contain water in an amount from about 25% to about 40%, about 25% to about 39%, about 25%, to about 38%, about 25% to about 37%, about 25% to about 36%, about 25% to about 37%, about 25% to about 36%, about 25% to about 35%, about 25% to about 34%, about 25% to about 33%, about 25% to about 32%, about 25% to about 31%, about 25% to about 30%, about 25% to about 29%, about 25% to about 28%, about 25% to about 27%, about 25% to about 26%, or from about 26% to about 40%, about 26% to about 39%, about 26%, to about 38%, about 26% to about 37%, about 26% to about 36%, about 26% to about 37%, about 26% to about 36%, about 26% to about 35%, about 26% to about 34%, about 26% to about 33%, about 26% to about 32%, about 26% to about 31%, about 26% to about 30%, about 26% to about 29%, about 26% to about 28%, about 27% to about 27%, or from about 27% to about 40%, about 27% to about 39%, about 27%, to about 38%, about 27% to about 37%, about 27% to about 36%, about 27% to about 37%, about 27% to about 36%, about 27% to about 35%, about 27% to about 34%, about 27% to about 33%, about 27% to about 32%, about 27% to about 31%, about 27% to about 30%, about 27% to about 29%, about 27% to about 28%, or from about 28% to about 40%, about 28% to about 39%, about 28%, to about 38%, about 28% to about 37%, about 28% to about 36%, about 28% to about 37%, about 28% to about 36%, about 28% to about 35%, about 28% to about 34%, about 28% to about 33%, about 28% to about 32%, about 28% to about 31%, about 28% to about 30%, about 28% to about 29%, or from about 29% to about 40%, about 29% to about 39%, about 29%, to about 38%, about 29% to about 37%, about 29% to about 36%, about 29% to about 37%, about 29% to about 36%, about 29% to about 35%, about 29% to about 34%, about 29% to about 33%, about 29% to about 32%, about 29% to about 31%, about 29% to about 30%, or from about 30% to about 40%, about 30% to about 39%, about 30%, to about 38%, about 30% to about 37%, about 30% to about 36%, about 30% to about 37%, about 30% to about 36%, about 30% to about 35%, about 30% to about 34%, about 30% to about 33%, about 30% to about 32%, about 30% to about 31%, or from about 31% to about 40%, about 31% to about 39%, about 31%, to about 38%, about 31% to about 37%, about 31% to about 36%, about 31% to about 37%, about 31% to about 36%, about 31% to about 35%, about 31% to about 34%, about 31% to about 33%, about 31% to about 32%, or from about 32% to about 40%, about 32% to about 39%, about 32%, to about 38%, about 32% to about 37%, about 32% to about 36%, about 32% to about 37%, about 32% to about 36%, about 32% to about 35%, about 32% to about 34%, about 32% to about 33%, or from about 33% to about 40%, about 33% to about 39%, about 33%, to about 38%, about 33% to about 37%, about 33% to about 36%, about 33% to about 37%, about 33% to about 36%, about 33% to about 35%, about 33% to about 34%, or from about 34% to about 40%, about 34% to about 39%, about 34%, to about 38%, about 34% to about 37%, about 34% to about 36%, about 34% to about 37%, about 34% to about 36%, about 34% to about 35%, or from about 35% to about 40%, about 35% to about 39%, about 35%, to about 38%, about 35% to about 37%, about 35% to about 36%, or from about 36% to about 40%, about 36% to about 39%, about 36%, to about 38%, about 36% to about 37%, or from about 37% to about 40%, about 37% to about 39%, about 37% to about 38%, or from about 38% to about 40%, about 38% to about 39%, or from about 30% to about 40%.

The moisture content of the dough may be based on the amount of liquid water mixed with the dry mix prior to or during extrusion, e.g., such that any additional moisture added in the form of steam during extrusion may further increase the foregoing values. Further, the amount of moisture in the pasta dough may be measured based on the total weight of the pasta dough, including any optional additives, and may account for all sources of moisture in the dough (e.g., both added moisture and moisture present in the constituent components of the dough before combination).

In addition to the dry mix and water, the pasta dough may contain additional optional ingredients. When additional ingredients are used, the ingredients may be added to the dough at any time during the production process, e.g., before extrusion of the dough. Controlling the type, quality, and quantity of ingredients added to the dough can control the taste, texture, and performance of the resulting pasta product, both during processing and during subsequent cooking and consumption. Example ingredients that may be added to the dough include, but are not limited a variety of natural and artificial flavors, herbs, spices, cheeses and the like also can be added to the dough, if desired. In one application, salt may be added to the dough, for example up to 3 weight percent. The added salt may improve hydration by creating voids within the structure of the dough after the salt dissolves during cooking. Highly soluble salts can dissolve during cooking, leaving fine trails or voids in the pasta structure that facilitates water penetration during cooking. In addition to or in lieu of salt, additional seasonings, spices, and/or flavorings may be added to the dough, e.g., in amounts of from 0.1 weight percent to 3 weight percent by weight based on the total weight of the dough.

Although the dough can include a variety of added ingredients besides the dry mix and water, the dough may be substantially free or entirely free of some ingredients, such as ingredients that change the performance of the dough during processing and/or the final pasta product.

In general, any suitable process may be used to blend the ingredients together to form the dough. In some examples, the ingredients (or a subset thereof) are mixed together and then introduced into an extruder. For example, the ingredients may first be mixed together in a preconditioner device to provide initial hydration of the components of the dry mix in preparation for subsequent extrusion. A preconditioner device may be useful to provide additional mixing and/or heating to the dough ingredients, particularly when using a traditional single screw pasta extruder. Alternatively, the constituent ingredients may be separately introduced into an extruder, for example sequentially through a feed inlet or simultaneously through separate feed inlets. In either case, the ingredients may be admixed or blend together, e.g., to form a compositionally homogenous pasta dough.

After forming the gluten-free extrudable pasta dough, the process of FIG. 1 includes extruding the extrudable pasta dough to form an extruded pasta product, as is known from traditional wheat-based pasta extrusion. To that end, the extruder system may include an extruder and a material delivery apparatus that may include one or multiple delivery apparatuses, to deliver the dry mix, water, and any optional ingredients to the extruder. The extruder will mix the ingredients and, in some instances, extrude the material through a forming or shaping die into a three dimensional shape where it can be cut into discrete pieces of a specific size.

As is known, the extruder may be a single screw extruder or twin-screw extruder. When the extruder is a twin screw extruder that includes two screws, the two screws can be positioned tangentially to one another, non-intermeshing, or intermeshing (e.g., overlapping). Further, the two screws can be operated so the screws co-rotate (i.e., so each screw rotates in the same direction) or counter-rotate (i.e., so each screw rotates in a direction opposite from the other screw).

To form an extruded pasta product that has a structure sufficient to withstand retort conditions, the amount of mechanical energy and/or thermal energy added to the extrudable pasta dough may be controlled during extrusion. For example, the amount of mechanical energy and thermal energy added to the extrudable pasta dough during extrusion may be controlled to produce an extruded pasta product defined by a bi-continuous matrix of starch and protein.

Thermal energy may be added to the extrudable pasta dough during extrusion by injecting steam into the dough during extrusion and/or hot extruding the dough (e.g., using an externally heated extruder barrel). In one example, thermal energy is added to the extrudable pasta dough by injecting steam into the dough downstream of preconditioner (if use) but upstream of any extruder mixing blocks (if used). For example, stream may be injected into the dough in the extruder at or adjacent the inlet of the extruder. The amount of steam added to the dough may be effective to partially or fully gelatinize the ungelatinized starch in the dough.

In some examples, the amount of steam injected into the dough is greater than 5 weight percent of the total weight of dough fed into the extruder, such as at least 7 weight percent, or at least 10 weight percent. For example, the amount of steam injected into the dough may range from 5 weight percent to 15 weight percent of the total weight of dough fed into the extruder, such as from 10 weight percent to 14 weight percent.

In addition to or in lieu of injecting steam into the extruder, the extruder may be externally heated by externally heating the extruder barrel, e.g., by passing a heat transfer fluids such as steam or heated fluids through a jacket of the extruder barrel. Through steam, external heating, and/or frictional heating, the pasta dough may be heated to a temperature effective to form a bi-continuous matrix of starch and protein in the resulting pasta product. In some examples, the pasta dough is heated above the glass transition temperature of the non-gluten protein contained in the dough. This can help the protein form a matrix of continuous and/or semi-continuous strands, which may be intermingled with a matrix of gelatinized protein formed through extrusion.

While the specific temperature at which the pasta dough is extruded may vary, in some applications, the dough is heated to achieve a die exit temperature greater than 65° C., such as a die exit temperature greater than 70° C., or a temperature greater than 80° C. For example, the pasta dough may be extruded to provide a die exit temperature ranging from 65° C. to 70° C.

In addition to imparting thermal energy into the extrudable pasta dough during extrusion, mechanical energy may also be imparted into the dough during extrusion. Mechanical energy can be imparted to the dough through the screw(s) of the extruder. The amount of mechanical energy added to the pasta dough during extrusion may be effective, in combination with the thermal energy added to the dough, to form a resulting pasta product that survives retort. In some examples, the amount of mechanical energy is effective to form a bi-continuous matrix of starch and protein in the resulting pasta product. For example, the mechanical energy imparted to the dough may achieve alignment of the protein molecules to form the protein matrix portion of the resulting pasta product.

In general, the extruded pasta dough may be extruded through an appropriate die head to create a desired shape. Alternatively, the pasta dough, whether extruded or not, may be sheeted or formed into geometries that cannot be created using an extruder die head. Example pasta shapes that may be formed include bowtie, spaghetti, ziti, rigatoni, linguine, fettuccine, macaroni, lasagna, penne, tagliatella, and manicotti.

As noted in FIG. 1, the formed pasta product may optionally be dried (16). Any suitable techniques can be used to dry the extruded pasta product. For instance, the formed pasta product may be dried by forced air, belt drying, and fluidized bed drying techniques. As yet another example, the pasta product may be dried by freezing the product, e.g., freeze drying. Alternatively, the gluten-free pasta product may be frozen as individually quick frozen pasta (IQF gluten-free pasta) without dehydration. In some examples, the extruded formed pasta product is dried at a temperature less than 150° C., such as a temperature less than 100° C., a temperature less than 75° C., or a temperature less than 50° C. Drying the extruded formed pasta product slowly at a comparatively lower temperature may help avoid checking problems that can occur if the pasta is dried faster at a higher temperature.

In some examples, the extruded formed pasta product produced is dried so that the dry pasta product contains a moisture content of about 9%, 10%, 11%, 12%, 13%, 14% or 15%. To this end, the moisture content of the “dried” extruded pasta may be in the range from about 9% to about 15%, about 9% to about 14%, 9% to about 13%, 9% to about 12%, 9% to about 11%, 9% to about 10%, or from about 10% to about 15%, about 10% to about 14%, 10% to about 13%, 10% to about 12%, 10% to about 11%, or about 11% to about 15%, about 11% to about 14%, 11% to about 13%, 11% to about 12%, or about 12$ to about 15%, about 12% to about 14%, 12% to about 13%, or about 13% to about 15%, about 13% to about 14%, or about 14% to about 15%.

Thereafter and referring back to FIG. 1, the extruded gluten-free pasta product dried or otherwise may be usefully incorporated into a retort container with a sauce and other ingredients and then closed and exposed to retort conditions. For example, the pasta product may be used immediately, may be dried or may be frozen prior to being combined with a sauce either before, during, or after incorporating the pasta product in a retort container, which is thereafter subjected to retort conditions. Advantageously, the resulting retorted pasta product exhibits suitable textural firmness and sauce uptake without substantially disintegrating or decomposing and may have a texture comparable to conventional wheat pasta.

As noted, the optionally dried pasta product is incorporated into a retort container with a sauce and, optionally with other ingredients, and the container is closed to provide closed, retortable container (18).

### Sauce

As noted above, the pasta product (i.e., the extruded or otherwise formed pasta product), dried or otherwise, is mixed with a sauce in the form of a liquid so that the pasta will be in contact with the sauce. The pasta product may be mixed before, during, or after incorporating the pasta product into a retort package.

The nature of the sauce component will depend upon the type of product desired and the condiments desired or sought to be included in the sauce, and may contain ingredients such as spices, for example, oregano, parsley, basil; flavorings, for example, garlic, sugar, pepper, chili flakes, onion; corn syrup; vegetable oil; salt; and the like. Of course, the ingredients used and the amounts of ingredients will be determined by the taste desired for the sauce component.

It is contemplated that any sauce suitable for mixing with pasta could be used in the described product. To that end, it is contemplated that the sauce may be a tomato-based sauce such as Marinara, or Alfredo, Bolognese, Amatriciana, Frutti di mare, Salsa di Noci, Pesto, Pomodoro, Bechamel, Vodka sauce, butter garlic, and the like.

In one aspect, the sauce is primarily tomato-based and, as such will typically have a pH of less than 4.6, have a taste which is compatible with the other components of the product, and have a viscosity such that the sauce surrounds the pasta and other components of the pasta product when packed in containers. The desired acidity may be a result of the tomato base or may be provided in the sauce by the inclusion of any of food grade acids. Since tomato products have both a taste which is compatible with many pasta products and a pH of less than 4.6, it is generally preferred to use tomato sauce or paste, with or without additional food grade acids, as an acid food in the preparation of the sauce component. In some instances, the sauce, particularly if it is a tomato-based sauce will have a pH of about 4.6, 4.5, 4.4, 4.3, 4.2, or about 4.1.

### Packaging

The retortable container may take any suitable form. Merely by way of example, the sealable container may be in the form of a bottle, a can, a jar, a pouch, bag, sealable tray, or other closable structure sufficient to withstand retort conditions. The retortable container can be manufactured from materials such a metal, glass, or plastic. For example, the retortable container may be a multi-layered laminated paper board container. As another example, the retortable container may be a rigid plastic tray, cup, jar, can, bowl, or other shaped container. The sealable container may be in the form of a box (for example a plastic or cardboard box), a bag (for example a plastic bag, paper bag or foil bag) or a pouch (for example a plastic pouch or retort pouch), a tray, multi-component tray, cup, or other suitable package type that can withstand retort processing conditions.

In this regard, the package will provide a total volume of the retorted food product (total volume of pasta and sauce) between about 4 oz. to about 32 oz., or from about 8 oz. to about 24 oz., or from about 8 oz. to about 16 oz., or from about 8 oz. to about 14 oz. Within that total volume, the pasta may be present in a range from about 1% to about 40% by volume with the remainder being sauce. As such, the pasta may be present in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, or about 40% by volume.

### Retort

After incorporating the pasta product, sauce, and optional ingredients, in the retortable container and closing (sealing) the container, the container is subjected to retort conditions (20). In a typical retort process, the retort container is transported through or placed in a high pressure vessel (e.g., water bath) and then heated for a predetermined period of time. For example, the retortable container may be heated for a period of at least 5 minutes, such as at least 10 minutes, at least 15 minutes, or at least 30 minutes. The retort container and the contents disposed in the container may be heated at a temperature of at least 100° C. for that period of time, such as at least 125° C., or at least 130° C. For example, the retort container and contents therein may be heated at a temperature ranging from 125° C. to 135° C.

In some applications, the retort container is heated under elevated pressure. In either case, as the exterior surface of the container is heated, the enclosed contents are heated and the internal pressure within the container increases. For example, the gluten-free pasta may be retorted in a rotary style retort, which may impart high shear forces to the contents of the retort container and have a tendency to cause disintegration of soft food matter if it does not have sufficient strength and/or textual rigidity.

The retorted pasta product may exhibit a textural firmness, measured as described below, of at least about 300 grams and, in some instances exhibit a textural firmness between about 300 grams and about 550 grams.

The following examples may provide additional details about retortable pasta products and processing techniques in accordance with this disclosure.

### Example 1

In accordance with the above description, a retorted pasta product containing a pasta product in a marinara sauce may be formed and the pasta product may be formed from a dry mix containing greater than about 50% chickpea flour, lentil flour, or a mixture of chickpea and lentil flour; added (exogenous starch) in an amount from about 10% to about 30%, and one or more emulsifiers in an amount from about 1% to about 5%.

### Example 2: Sauce Uptake

As previously intimated, one issue with previous attempts to providing gluten-free pastas is their less than desirable ability to absorb or uptake sauce. As a result, the amount of sauce used to provide a palatable and enjoyable product is greater than that required for wheat-based pasta. Alternatively, if the amount of sauce is reduced, the resulting product does not meet consumer taste expectations.

It has been found that a correlative measure of sauce uptake can be determined using a Rapid Visco Analyser (RVA), which is a rotational viscometer that is able to continuously record the viscosity of a sample under conditions of controlled temperature and shear. In connection with the described pasta products, it is believed that the peak viscosity may indicate one or more of the water-holding (and thus sauce holding) capacity and/or the degree of retrogradation of the starch present in the pasta product. In this regard, it may be useful to test the pasta product prior to combining with a sauce and retorting the combined ingredients and after retorting of the pasta product and sauce.

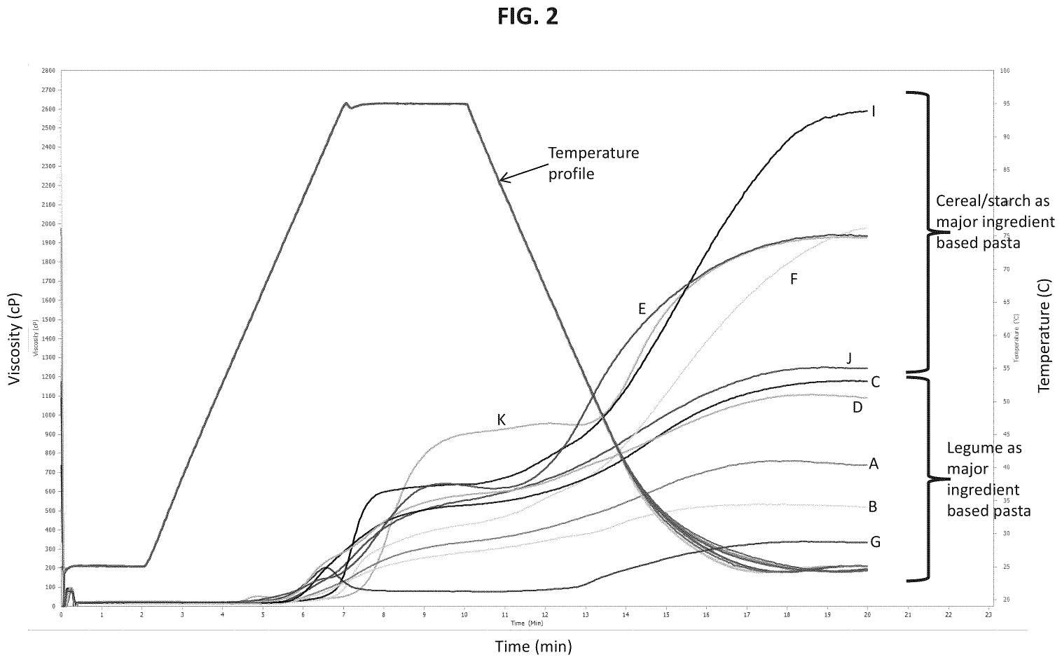

In those instances where the pasta product is tested prior to combining with a sauce and retorting, a pasta product made according to the described process (i.e., according to FIG. 1) that has been dried is then ground so the pasta product passes through a 1 mm sieve and combined with water to provide a test mixture containing 10.7 wt % solids. Thereafter, the test mixture is loaded into the analyzer where the sample is subjected to the temperature profile (about 25° C. to about 95° C. for the time duration (about 20 minutes) and the plot of the results is generated as shown in FIG. 2.

The following samples were tested.

TABLE 1

| Sample | Dry Mix Ingredients |
|---|---|
| A | Organic green lentil flour |
| B | Organic chickpea flour |
| C | Yellow lentil flour |
| D | Chickpea, tapioca, pea protein, |
| | xanthan gum |
| E | Corn flour, rice flour, quinoa flour |
| | (3%), emulsifiers: mono- and |
| | diglycerides of fatty acids |
| F | Semolina (from Canadian amber |
| | Durum wheat), gluten (wheat |
| | gluten) |
| G | Red lentil flour, white rice, pea |
| | protein |
| H | Organic brown rice flour |
| I | Semolina (wheat), egg white, |
| | niacin, ferrous sulfate (iron), |
| | thiamine mononitrate, riboflavin, |
| | folic acid |
| J | Semolina (wheat), durum wheat |
| | flour |
| K | Organic corn flour, organic |
| | brown rice flour, organic quinoa |
| | flour |

Referring to FIG. 2, plots generated as a result of the RVA measurement show that those products having an earlier first peak exhibit quicker or faster water absorption, which may be indicative of more gelatinized/cooked starch in the product. In addition, those products that have a higher first peak/higher peak viscosity exhibit greater water absorption and swelling which indicates that the starch membrane is thinner and more pliable, and may also be indicative of relatively higher content of native starch which may be indicative to lower fragility/brittleness. On the other hand, a lower peak viscosity could lead to more fragility/brittleness, which was a common observation when pasta containing a major amount of legume was tested.

### Example 3: Textural Firmness/Hardness

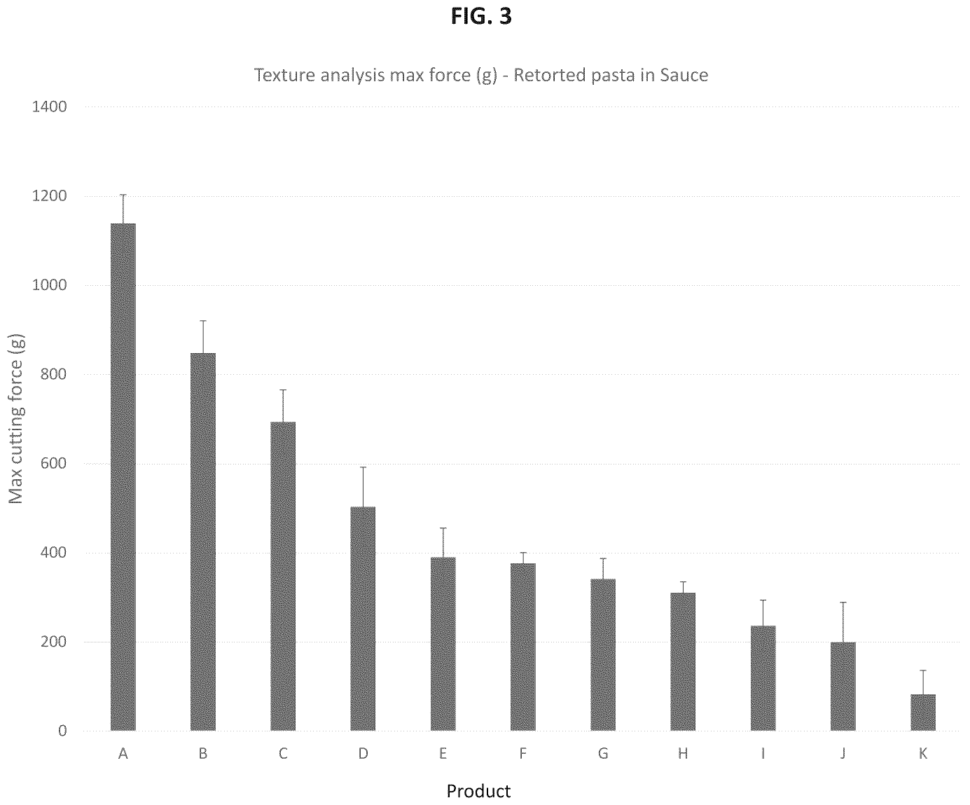

FIG. 3 is a plot showing textual firmness values for exemplary retorted pasta products produced in accordance with the present disclosure (i.e., the process shown in FIG. 1). Firmness/Hardness was quantitatively measured using a TA.XT Plus Texture Analyzer with a 45 degree angle chisel blade. To measure textual firmness, a 50 kg load cell was attached to the TA.XT Plus Texture Analyzer and calibrated to 1 kg. The TA.XT Plus Texture Analyzer was further fitted with a 45° angle chisel blade. The blade height was calibrated for a 20 mm test distance.

Once calibrated, individual pieces of retorted pasta product removed from the sauce were washed and then loaded into the test cylinder. The texture of the sample was then measured in compression mode with a trigger force of 5 g, a pre-test speed of 1 mm/sec, a test speed of 0.5 mm/second, and a post-test speed of 10 mm/sec. The total duration of a single test was 25 seconds. The resulting data is expressed as a curve of kg force over-time in seconds. The first peak, i.e., the initial force in pressing the retorted pasta demonstrated its springiness and the second peak was the total force required to cut the retorted pasta.

The samples identified in Table 1 were tested according to the above procedure. As illustrated in FIG. 3, each of the samples survived retort and exhibited texture firmness as high as, and in most cases, higher than the wheat pasta comparison samples F, I, and J. Generally, the samples according to the present disclosure have a textural firmness of at least 300 g.

It was also found that, based on sensory panel testing the desired textural firmness ranged from about 300 g to about 550 g. To this end, it was found that when the textural firmness exceeded about 600 g, the pasta product was deemed to exhibit an undesirably crunchy or hard texture, which resulted in a negative organoleptic perception by the sensory panel. Accordingly, desired products have a desired textural firmness between about 300 g to about 550 g.

While the concepts of the present disclosure are susceptible to various modifications and alternative forms, specific exemplary embodiments of the disclosure have been shown by way of example in the drawings. It should be understood, however, that there is no intent to limit the concepts of the present disclosure to the particular disclosed forms; the intention is to cover all modifications, equivalents, and alternatives falling within the spirit and scope of the invention as defined by the claims.

1. A process for preparing a retorted product comprising:
providing a gluten-free pasta product that comprises a flour comprising (a) gluten-free flour that includes (i) a non-cereal or pulse flour, (ii) a cereal flour or (iii) mixtures thereof, (b) a starch, and (c) an emulsifier;
combining the pasta product with a sauce before, during or after incorporating the pasta product into a closed container; and
retorting the pasta product in the closed container to produce a retorted pasta product.

2. The process of claim 1, wherein the gluten-free pasta product is formed from a dough containing from about 60% to about 75% of a dry mix and from about 25% to about 40% of a water, wherein the dry mix includes a flour comprising (a) gluten-free flour that includes (i) a non-cereal or pulse flour, (ii) a cereal flour or (iii) mixtures thereof, (b) a starch, and (c) an emulsifier.

3. The process of claim 1 wherein retorting the pasta product in the closed container comprises heating the pasta product in the closed container at a temperature greater than or equal to 125° C. for a period of at least 10 minutes.

4. The process of claim 1, wherein the retorted pasta product exhibits a textural firmness of at least 500 grams.

5. The process of claim 2, wherein the dry mix comprises from about 50% to about 80% of a flour comprising (a) gluten-free flour that includes (i) a non-cereal or pulse flour, (ii) a cereal flour or (iii) mixtures thereof; from about 5% to about 35% starch; and from about 0.5% to about 6% emulsifier.

6. The process of claim 1 wherein the flour is a legume flour.

7. The process of claim 6 wherein the pulse flour is a pulse flour.

8. The process of claim 6, wherein the gluten free pasta product comprises from about 19% to about 25% protein, from about 55% to about 70% carbohydrate, and from about 5% to about 25% fiber.

9. The process of claim 1 wherein the flour is a cereal flour.

10. The process of claim 9 wherein the cereal flour is selected from corn, rice, quinoa, and mixtures thereof.

11. The process of claim 10 wherein the gluten free pasta product comprises from about 2% to about 25% protein, from about 50% to about 90% carbohydrate, and from about 1% to about 7% fiber.

12. A retorted food product comprising a container having undergone retort that contains a gluten-free pasta product having a bi-continuous matrix of protein and starch, with the pasta product immersed in a sauce.

13. The retorted food product of claim 12, wherein the retorted food product retorted pasta exhibits a textural firmness of at least 300 grams.
